(19) United States
(12) Patent Application Publication
(10) Pub. No.: US 2010/0015981 A1
(43) Pub. Date: Jan. 21, 2010

(54) CELLULAR RADIO COMMUNICATION SYSTEM AND HANDOVER METHOD

(76) Inventors: Yoshihito Shimazaki, Tokyo (JP); Takeshi Umehara, Tokyo (JP)

Correspondence Address: FOLEY AND LARDNER LLP;SUITE 500, 3000 K STREET NW, WASHINGTON, DC, 20007, US

(21) Appl. No.: 12/302,184

(22) PCT Filed: May 23, 2007
(86) PCT No.: PCT/JP2007/060946

§ 371 Date: Feb. 20, 2009

(30) Foreign Application Priority Data
May 24, 2006 (JP) 2006-143538

(51) Int. Cl. H04W 36/00

(52) U.S. Cl. 455/436

(57) ABSTRACT

A cellular radio communication system according to a first aspect of the present invention includes a plurality of base stations to send control information to a mobile station belonging to a cell controlled by each of the plurality of base stations for enabling handover to a cell adjacent to a cell controlled by each of the plurality of base stations. Further, the control information sent from at least some of the plurality of base stations concerns a smaller number of cells than a total number of adjacent cells to the cell controlled by each of the plurality of base stations.

### TECHNICAL FIELD

The present invention relates to a cellular radio communication system and, particularly, to a handover process of a mobile station in a cellular radio communication system.

### BACKGROUND ART

A DS-CDMA (Direct Spread Code Division Multiple Access) cellular radio communication system is in practical use. In DS-CDMA system, adjacent cells are distinguished by spread codes, so that there are no constraints on frequency reuse in cell design. Therefore, the DS-CDMA cellular radio communication system allows flexible arrangement of cells with different radii according to traffic distributions or the like without the constraint of regularity of cell arrangement. It also allows easy implementation of a hierarchical cell structure, which involves hierarchical placement and spread of cells with different radii. The hierarchical cell structure is such that a base station (BS) with a smaller cell radius is placed within a cell that is covered by another base station (see Patent Citation 1, for example). In the following description, cells with the largest, intermediate, and smallest radii are referred to as macro, micro, and pico cells, respectively, in order to distinguish the cells with different radii.

The cellular radio communication system implements handover to switch a cell for providing service to a mobile station (MS) into another cell when a mobile station moves from one cell to another. A mobile station measures the qualities of a signal that is transmitted from a base station of an adjacent cell, which include a received signal level and SIR (Signal to Interference power Ratio). It then sends the measurement result to a base station and a radio network controller (RNC) that controls the handover process. A radio network controller determines whether to implement handover based on the measurement result sent from the mobile station and carries out the handover by sending necessary control information to the base station and the mobile station.

The mobile station retains adjacent cell information that is sent by the base station from which service is provided currently through a downstream control channel. The mobile station refers to the adjacent cell information to thereby determine an adjacent cell on which the signal qualities are to be measured upon the handover. The adjacent cell information is necessary information for measuring the qualities of a signal transmitted from a base station of an adjacent cell. In cellular radio communication systems in which base stations are asynchronous with each other such as W-CDMA cellular radio communication systems, a spread code which is used by a base station of an adjacent cell is sent as adjacent cell information to a mobile station. The mobile station sequentially performs dispreading process using the spread code which is contained in the adjacent cell information sent from the base station, thereby limiting the number of spread codes to be used for the measurement of communication quality to the number of adjacent cells. On the other hand, in cellular radio communication systems in which base stations are synchronous with each other such as cdma-2000 cellular radio communication systems, the same spread code is used with different delays added for each base station. In this case, delay information of a spread code regarding a base station of an adjacent cell is sent as adjacent cell information.

Although the above description on the handover is given with respect to a DS-CDMA cellular radio communication system as an example, a mobile station is able to determine an adjacent cell on which the signal qualities are to be measured by referring to adjacent cell information sent from a base station in other types of cellular radio communication systems such as FH-CDMA (Frequency hopping Code Division Multiple Access) and FDMA (Frequency Division Multiple Access). In FDMA systems, for example, a frequency channel which is used by a base station of an adjacent cell is sent as adjacent cell information to a mobile station.

### [Patent Citation 1]

International Publication WO 03/007645

### DISCLOSURE OF INVENTION

### Technical Problem

With the use of the hierarchical cell structure and the positive introduction of micro and pico cells, the cell radius become increasingly smaller and the number of adjacent cells increases accordingly. The increase in the number of adjacent cells causes an increase in adjacent cell information to be stored in a base station, which leads to an increase in workload to make the setting to a base station upon provisioning. In regard to a mobile station, the increase in the number of adjacent cells causes an increase in storage area to store adjacent cell information and an increase in processing amount for the handover process. Further, the increase in the number of adjacent cells results in the frequent occurrence of handover, which can lead to heavier processing burden on a base station, a mobile station, and a radio network controller that controls the handover process.

The present invention has been accomplished to solve the above problems and an object of the present invention is thus to reduce the effect of the above problems caused by an increase in the number of adjacent cell numbers.

### Technical Solution

A cellular radio communication system according to a first aspect of the present invention includes a plurality of base stations to send control information to a mobile station belonging to a cell controlled by each of the plurality of base stations for enabling handover to a cell adjacent to a cell controlled by each of the plurality of base stations. Further, the control information sent from at least some of the plurality of base stations concerns a smaller number of cells than a total number of adjacent cells to the cell controlled by each of the plurality of base stations.

In such a structure, it is possible to reduce the amount of control information to be set at a base station, which is adjacent cell information such as a spread code used in an adjacent cell in W-CDMA system. Further, because the amount of adjacent cell information sent from a base station becomes smaller, it is possible to reduce an increase in a storage area of a mobile station to retain adjacent cell information. Furthermore, because the number of cells whose qualities are to be measured by a mobile station upon handover also becomes smaller, it is possible to reduce the processing amount of a mobile station to enable an efficient handover process.

If the cellular radio communication system according to the first aspect has a hierarchical cell structure where cells respectively controlled by the plurality of base stations are arranged in a hierarchical fashion, the control information sent from at least some of the plurality of base stations is preferably limited to those concerning a base station controlling a cell belonging to the same hierarchy as a cell controlled by a sender base station. In such a structure, when using the hierarchical cell structure, it is possible to impose a restriction on the movement between cells to a mobile station to perform the handover. It is thereby possible to prevent the frequent occurrence of handover even if the number of adjacent cells increases. This allows reduction of handover processing burden on a base station, a mobile station and a radio network controller.

If the cellular radio communication system according to the first aspect has a hierarchical cell structure which includes a first cell in an upper hierarchy, a second cell being adjacent to the first cell and covering an indoor zone including an entrance of a building existing within a zone covered by the first cell, and a third cell being adjacent to the first cell and the second cell and covering an indoor zone excluding the entrance of the building, the control information sent from a base station controlling the third cell preferably contains information concerning the second cell and does not contain information concerning the first cell. In such a structure, it is possible to reduce the amount of information of adjacent cells to be sent from a base station and prevent the frequent occurrence of unnecessary handover while ensuring the practical mobility of a mobile station.

If the cellular radio communication system according to the first aspect is a DS-CDMA cellular radio communication system, a spread code used by a base station controlling an adjacent cell may be sent as the control information.

A handover method according to a second aspect of the present invention is a handover process method in a cellular radio communication system including a plurality of base stations. Specifically, it includes a step of transmitting control information concerning limited cells of a smaller number than a total number of adjacent cells from a base station to a mobile station, a step of measuring a signal quality of the limited cells by a mobile station based on the control information, and a step of determining a handover destination cell of the mobile station from the limited cells based on a measurement result of the mobile station.

With such a handover method, it is possible to reduce the amount of control information to be set at a base station, which is adjacent cell information. Further, because the amount of adjacent cell information sent from a base station becomes smaller, it is possible to reduce an increase in a storage area of a mobile station to retain adjacent cell information. Furthermore, because the number of cells whose qualities are to be measured by a mobile station upon handover also becomes smaller, it is possible to reduce the processing amount of a mobile station to enable an efficient handover process.

### ADVANTAGEOUS EFFECTS

The present invention reduces the amount of adjacent cell information, such as a spread code used in adjacent cells in W-CDMA system, to be sent from a base station, thereby providing a cellular radio communication system and a handover method which are robust against an increase in the number of adjacent cells.

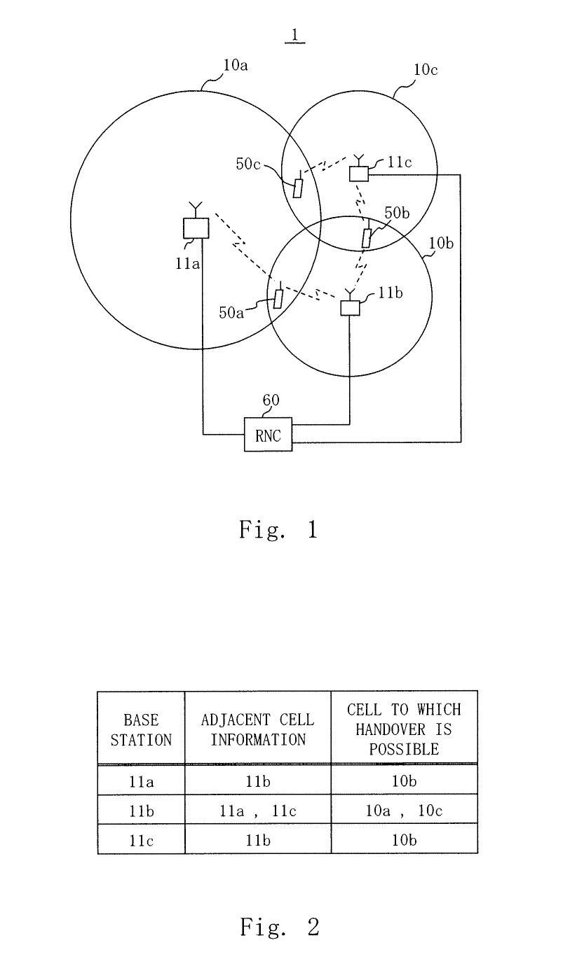

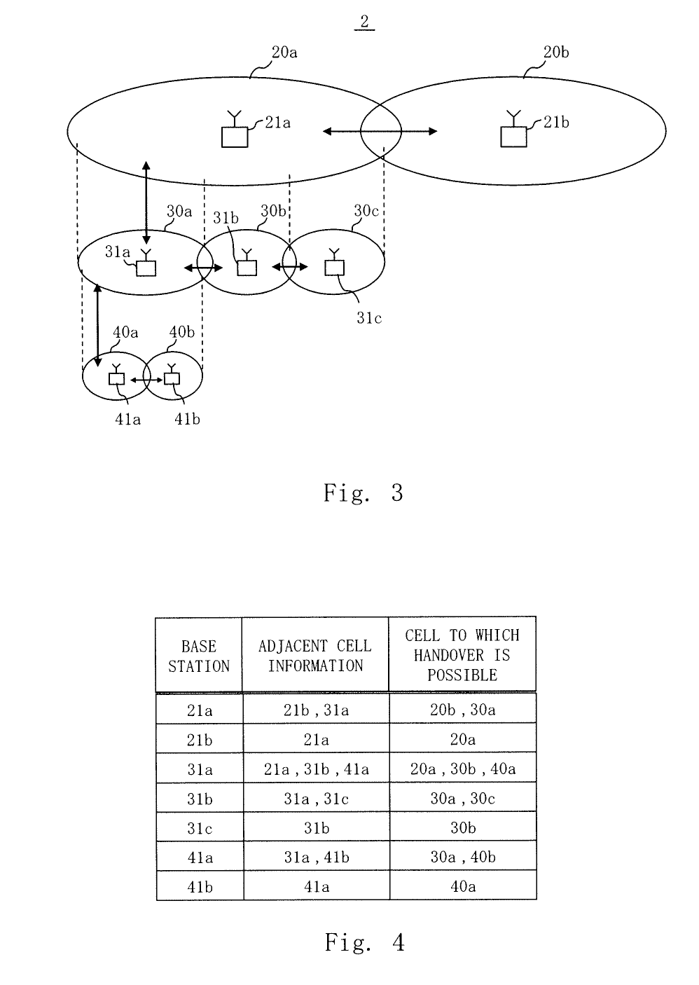

### BRIEF DESCRIPTION OF DRAWINGS

[FIG. 1] A schematic diagram of a cellular radio communication system according to a first embodiment of the present invention.

[FIG. 2] A view showing exemplary setting of adjacent cell information according to the first embodiment of the present invention.

[FIG. 3] A schematic diagram of a cellular radio communication system according to a second embodiment of the present invention.

[FIG. 4] A view showing exemplary setting of adjacent cell information according to the second embodiment of the present invention.

### EXPLANATION OF REFERENCE

1, 2 Cellular radio communication system
10a, 10b, 10c Cell
20a, 20b, 20c Macro cell
30a, 30b, 30c Micro cell
40a, 40b Pico cell
11a, 11b, 11c Base station
21a, 21b, 21c Base station
31a, 31b, 31c Base station
41a, 41b Base station
50a, 50b, 50c Mobile station
60 Radio network controller

### BEST MODES FOR CARRYING OUT THE INVENTION

Specific embodiments of the present invention are described hereinafter in detail with reference to the drawings. In the drawings, the same elements are denoted by the same reference symbols and redundant description is omitted as appropriate for simplification of the description. In the following embodiments of the invention, the present invention is applied to a W-CDMA cellular radio communication system.

### First Embodiment

FIG. 1 shows the structure of a cellular radio communication system 1 according to this embodiment. In FIG. 1, cells 10a, 10b and 10c indicate the cells which are controlled by base stations 11a, 11b and 11c, respectively. For example, a mobile station that exists within the cell 10a, e.g. a mobile station 50a in FIG. 1, is connected with the base station 11a by a radio interface. Similarly, mobile stations that exist within either of the other two cells 10b and 10c, e.g. mobile stations 50b and 50c in FIG. 1, are connected with the base station 11b or 11c by a radio interface. The radio network controller 60 is connected with the base stations 11a, 11b and 11c to implement the management of radio resources to be allocated to the base stations 11a, 11b and 11c, the control of the base stations 11a, 11b and 11c, the control of handover of the mobile stations 50a, 50b and 50c, and so on.

In the cellular radio communication system 1, handover is executed as follows. The base stations 11a, 11b and 11c send notification information containing adjacent cell information to a mobile station within cells respectively covered by those base stations using a downstream control channel. In the W-CDMA cellular radio communication system 1, a spread code which is used by a base station of an adjacent cell is sent as adjacent cell information to a mobile station.

The mobile stations 50a, 50b and 50c perform despreading process using the spread code contained in the adjacent cell information which is sent from the base stations 11a, 11b and 11c, to which they respectively belong, thereby measuring the qualities of a signal from a base station of an adjacent cell, such as a received signal level and SIR. Then, the mobile stations 50a, 50b and 50c send the measurement results to the base stations 11a, 11b and 11c, to which they respectively belong, and the radio network controller 60.

The radio network controller 60 executes a handover process based on the measurement results which are sent from the mobile stations 50a, 50b and 50c.

The cellular radio communication system 1 of this embodiment is characterized in that the adjacent cell information sent from the base stations 11a, 11b and 11c do not necessarily include information concerning all adjacent cells. In other words, the contents of adjacent cell information sent from at least some of base stations are limited to those concerning the smaller number of adjacent cells than the total number of adjacent cells.

FIG. 2 shows an example of specific settings of adjacent cell information sent from the base stations 11a, 11b and 11c. For example, the adjacent cell information sent from the base station 11a contains a spread code which is used by the base station 11b but does not contain a spread code which is used by the base station 11c. Therefore, a mobile station which belongs to the cell 10a is able to perform handover to the cell 10b but is unable to perform direct handover to the adjacent cell 10c.

On the other hand, the adjacent cell information sent from the base station 11b contains a spread code which is used by the base station 11a and a spread code which is used by the base station 11c. Therefore, a mobile station which belongs to the cell 10b is able to perform handover to the cells 10a and 10c.

Further, the adjacent cell information sent from the base station 11c contains a spread code which is used by the base station 11b but does not contain a spread code which is used by the base station 11a. Therefore, a mobile station which belongs to the cell 10c is able to perform handover to the cell 10b but is unable to perform direct handover to the adjacent cell 10a.

With such setting of adjacent cell information, a combination of cells between which handover is possible is limited, which can impede the mobility of a mobile station. A mobile station is unable to perform handover to a cell for which a spread code is not received as adjacent cell information. In this case, a mobile station needs to be once disconnected from a radio network, perform network search for capturing a connectable cell, register positional information to a connectable cell and then enter a stand-by mode.

However, even where cells are adjacent to each other, there is a combination of adjacent cells between which a mobile station does not physically move in consideration of geographical restrictions, a route of a user who has the mobile station and so on. If the above constraints are imposed on the handover between such cells, the practical mobility of a mobile station is still assured.

For example, consider the situation where the cell 10a covers the outdoors, the cell 10b covers a building floor with an entrance, and the cell 10c covers the inside of the building. In such a case, because a user inside the building goes to the outdoors through the building entrance, the practical mobility of a mobile station can be insured as long as the mobile station which belongs to the cell 10c is able to perform handover sequentially from the cell 10c through the cell 10b to the cell 10a.

As described above, by limiting the adjacent cell information sent from a base station to those concerning a smaller number of adjacent cells than the total number of adjacent cells, it is possible to reduce the amount of adjacent cell information to be set at a base station. This enables the reduction of workload for making the setting to a base station upon provisioning.

Further, because the amount of adjacent cell information sent from a base station becomes smaller, it is possible to reduce an increase in a storage area of a mobile station to retain adjacent cell information. Furthermore, because the number of cells whose qualities are to be measured by a mobile station upon handover also becomes smaller, it is possible to reduce the processing amount of a mobile station to enable an efficient handover process.

In addition, by imposing a restriction on the movement between cells to a mobile station to perform the handover, it is possible to prevent the frequent occurrence of handover even if the number of adjacent cells increases. This allows reduction of handover processing burden on a base station, a mobile station and a radio network controller.

### Second Embodiment

In this embodiment, the present invention is applied to a network with a hierarchical cell structure. FIG. 3 shows the structure of a cellular radio communication system 2 according to this embodiment. Mobile stations and a radio network controller are not illustrated in FIG. 3. Referring to FIG. 3, macro cells 20a and 20b are controlled by base stations 21a and 21b, respectively. Micro cells 30a, 30b and 30c are controlled by base stations 31a, 31b and 31c, respectively. Pico cells 40a and 40b are controlled by base stations 41a and 41b, respectively.

The micro cells 30a, 30b and 30c are placed in a hierarchical fashion within a zone which is covered by the macro cell 20a. The micro cells 30a, 30b and 30c may be placed in order to cover a zone on which traffic concentrates, to cover a zone in which the communication quality with the base station 21a is not high enough due to the presence of an obstacle, for example. The pico cells 40a and 40b are placed in a hierarchical fashion within a zone which is covered by the micro cell 30a. The pico cells 40a and 40b may be placed in order to cover the inside of a building which is included in the macro cell 20a, for example.

Typically, the cell radius of the macro cells 20a and 20b is about several kilometers to several tens of kilometers, the cell radius of the micro cells 30a, 30b and 30c is about several hundreds of meters, and the cell radius of the pico cells 40a and 40b is about ten to several tens of meters. The present invention, however, is not limited to the cases with such cell radii. The hierarchical structure with three hierarchies is merely an example, and the hierarchical structure may include two hierarchies or four or more hierarchies.

The cellular radio communication system 2 of this embodiment is characterized in that the handover of a mobile station between cells with different hierarchies is restricted. The double-headed arrows illustrated in FIG. 3 indicate the relationship of adjacent cells between which the handover is possible. Specifically, the handover between a macro cell hierarchy and a micro cell hierarchy can be carried out between the macro cell 20a and the micro cell 30a and cannot be carried out between the macro cell 20a and the micro cell 30b and between the macro cells 20a and 20b and the micro cell 30c. The handover between a micro cell hierarchy and a pico cell hierarchy can be carried out between the micro cell 30a and the pico cell 40a and cannot be carried out between the micro cells 30a and 30b and the pico cell 40b.

In the following description, the cells that allow the handover between different hierarchies, which are the cells 20a, 30a and 40a, are referred to as entrance cells. The cells that allow the handover within the same hierarchies but does not allow the handover between different hierarchies, which are the cells 20b, 30b, 30c and 40b, are referred to as sub cells.

FIG. 4 shows an example of settings of adjacent cell information sent from each base station included in the cellular radio communication system 2 where the combination of cells between which the handover is possible is limited. For example, the adjacent cell information sent from the base station 21a that controls the macro cell 20a, which serves as an entrance cell, contains a spread code which is used by the base station 21b that controls the macro cell 20b in the same hierarchy and a spread code which is used by the base station 31a that controls the micro cell 30a in the lower hierarchy. However, the information does not contain spread codes which are used by the base stations 31b and 31c that control the micro cells 30b and 30c, respectively. Therefore, a mobile station which belongs to the macro cell 20a is able to perform handover to the micro cell 30a but is unable to perform direct handover to the adjacent micro cells 30b and 30c.

Further, the adjacent cell information sent from the base station 31a that controls the micro cell 30a, which serves as an entrance cell, contains spread codes which are used by the base station 21a in the upper hierarchy, the base station 31b in the same hierarchy, and the base station 41a in the lower hierarchy. However, the information does not contain a spread code which is used by the base stations 41b that controls the pico cell 40b in the lower hierarchy. Therefore, a mobile station which belongs to the micro cell 30a is able to perform handover to the macro cell 20a, the micro cell 30b and the pico cell 40a but is unable to perform direct handover to the adjacent pico cell 40b.

A specific example is the structure which includes a pico cell that covers the first floor of a two-storied building and a pico cell that covers the second floor of the two-storied building, where the pico cell for the first floor is set as an entrance cell which allows handover with a micro cell or a macro cell in the outdoors. Another example is the structure which includes a plurality of pico cells that cover an underground shopping area, where a zone with an entry door to the aboveground area such as a staircase and an escalator is set as an entrance cell and the other zones are set as sub cells.

In this way, the cells that are included in the cellular radio communication system 2 with the hierarchical cell structure are sorted to entrance cells which allow handover between different hierarchies and sub cells which only allow handover within the same hierarchy. This has the following advantages. First, the adjacent cell information sent from a base station is limited to those concerning a smaller number of adjacent cells than the total number of adjacent cells. This enables reduction of adjacent cell information to be set at a base station. This also enables reduction of workload for making the setting to a base station upon provisioning.

Second, because the amount of adjacent cell information sent from a base station becomes smaller, it is possible to reduce an increase in a storage area of a mobile station to retain adjacent cell information. Furthermore, because the number of cells whose qualities are to be measured by a mobile station upon handover also becomes smaller, it is possible to reduce the processing amount of a mobile station to enable an efficient handover process.

Third, by imposing a restriction on the movement between cells to a mobile station to perform handover, it is possible to prevent the frequent occurrence of handover even if the number of adjacent cells increases. This allows reduction of handover processing burden on a base station, a mobile station and a radio network controller.

Although the case where one entrance cell is placed in one cell hierarchy is described in this embodiment, a plurality of entrance cells may be placed in one cell hierarchy.

Further, although the W-CDMA cellular radio communication system is described in the first and the second embodiments, the present invention is applicable to cellular radio communication systems other than W-CDMA, such as other DS-CDMA systems including cdma 2000 and FH-CDMA system.

The present invention is not restricted to the above-mentioned embodiments, and various changes may be made without departing from the scope of the invention.

### INDUSTRIAL APPLICABILITY

The present invention is applicable to various cellular radio communication systems since it enables the reduction of the amount of adjacent cell information to be sent from a base station.

1.-7. (canceled)

8. A cellular radio communication system comprising:
a hierarchical cell structure including a first cell in an upper hierarchy and second and third cells in a lower hierarchy, the first cell overlaying on the second and the third cells, the second and the third cells being adjacent each other;
a first base station controlling the first cell;
a second base station controlling the second cell; and
a third base station controlling the third cell, wherein
first adjacent cell information sent by the first base station to enable handover of a mobile station from the first cell to an adjacent cell includes information concerning the second cell and does not include information concerning the third cell,
second adjacent cell information sent by the second base station to enable handover of a mobile station from the second cell to an adjacent cell includes information concerning the first cell and the third cell,
third adjacent cell information sent by the third base station to enable handover of a mobile station from the third cell to an adjacent cell is limited to those concerning the same hierarchy as the third cell, and
the third adjacent cell information includes information concerning the second cell and does not include information concerning the first cell.

9. The cellular radio communication system according to claim 8, wherein
the second cell covers an indoor zone including an entrance of a building existing within a zone covered by the first cell, and
the third cell covers the indoor zone excluding the entrance of the building.

10. The cellular radio communication system according claim 8, wherein
the cellular radio communication system is a DS-CDMA cellular radio communication system, and
the first to third adjacent cell information each includes a spread code used by a base station controlling an adjacent cell.

11. A handover method in a cellular radio communication system that comprises a hierarchical cell structure including a first cell in an upper hierarchy and second and third cells in a lower hierarchy, the first cell overlaying on the second and third cells, the second and third cells being adjacent each other, the handover method comprising:
a step of transmitting first adjacent cell information from a first base station that controls the first cell, the first adjacent cell information including information concerning the second cell and not including information concerning the third cell;
a step of transmitting second adjacent cell information from a second base station that controls the second cell, the second adjacent cell information including information concerning the first cell and the third cell;
a step of transmitting third adjacent cell information from a third base station that controls the third cell, the third adjacent cell information being limited to those concerning the same hierarchy as the third cell, the third adjacent cell information including information concerning the second cell and not including information concerning the first cell;
a step of measuring a signal quality of limited cells by a mobile station based on the control information sent from one of the first to the third base stations which provides service to the mobile station; and
a step of determining a handover destination cell of the mobile station from the limited cells based on a measurement result of the mobile station.

12. The handover method according to claim 11, wherein
the cellular radio communication system is a DS-CDMA cellular radio communication system, and
the first to third adjacent cell information each includes a spread code used by a base station controlling an adjacent cell.
